(19) United States
(12) Patent Application Publication
(10) Pub. No.: US 2003/0148694 A1
(43) Pub. Date: Aug. 7, 2003

(54) Absorbent composition and method of assembling

(76) Inventor: Farid F. Ghiam, Terre Haute, IN (US)

Correspondence Address: JENKENS & GILCHRIST, PC, 1445 ROSS AVENUE, SUITE 3200, DALLAS, TX, 75202, US

(21) Appl. No.: 10/358,865

(22) Filed: Feb. 5, 2003

Related U.S. Application Data
(60) Provisional application No. 60/354,567, filed on Feb. 5, 2002.
(60) Provisional application No. 60/361,414, filed on Feb. 28, 2002.

(51) Int. Cl. B32B 27/12; D04H 1/00; D04H 3/00; D04H 5/00

(52) U.S. Cl. 442/394; 442/327; 442/286; 442/353

(57) ABSTRACT

An absorbent composition utilizes extrusion lamination of a backsheet to an absorbent material for the creation of absorbent articles. The method of manufacturing the absorbent composition includes the steps of combining a topsheet material with an absorbent material and laminating a backsheet to said absorbent material.

### BACKGROUND OF THE INVENTION

1. Technical Field of the Invention

The invention relates generally to methods of combining composite materials, and more particularly to the assembly of composite materials in the manufacture of absorbent compositions and the resulting absorbent articles.

2. Description of Related Art

As discussed below in more detail, absorbent articles typically comprise an absorbent core with a topsheet on one side and a backsheet on the other side. The topsheet is designed to allow fluid to pass into the absorbent core. The absorbent core is designed to hold fluid. The backsheet is designed to separate the fluid saturated absorbent core from any clothing or bedding. Many variations are well known to increase the function of these various components and to add other features, such as increased comfort through the use of elastic or breathable materials. There are also many known methods for combining these components. Various bonding methods are disclosed below.

In the prior art it is common to attach a backsheet to the absorbent core via adhesive bonding. This method has various shortcomings, in particular, the adhesive binds the fibers of the absorbent core thereby reducing various absorbency qualities, such as strikethrough and rewet. Essentially, the adhesive reduces the capillary action between fibers of the absorbent core in an area adjacent the backsheet. This either reduces the performance of the article or requires a thicker absorbent core to compensate for the negative impact of the adhesive. A thicker core is not desired because of comfort considerations.

Another approach considered has been extrusion lamination of the backsheet onto the absorbent core. This process has not been used in the prior art because of various problems. One problem with this method is that the fibers of the absorbent core will melt into the backsheet, making a thick and relatively stiff backsheet. Another problem is that the extruded backsheet material is moved by capillary action into the voids between the fibers of the absorbent core. This leads to the use of more backsheet material and again a thicker backsheet than desired. Another problem is that the fibers of the absorbent core may extend through the freshly extruded backsheet, thus reducing the barrier effect of the backsheet unless a rather thick backsheet is extruded. Again, a thick backsheet is not desired.

It is common in the art for one manufacturer to produce films, another to produce core materials, and a third to combine these materials into an end product such as a pantiliner, sanitary pad, diaper, adult incontinence product, food tray, absorbent towel, spill control pillow, wiping article, mattress cover, or other absorbent article. Typically the raw materials are provided to the third manufacturer in a narrow format with a width on the order of one to two times the width of the desired absorbent article. Typically the topsheet and at least one absorbent core are bonded together into a composite. A backsheet is then applied to this composite with an adhesive which binds all three components together. From this the final product is cut.

This process limits the manufacturing line to a width equal to the width of the final product, or at most twice the width of the final product. This process is also inefficient because the materials must be rolled, stored and transported several times between formation of the various components and cutting of the final product. Another problem with this method is that the adhesive binds the fibers of the absorbent core and reduces the absorbency of the final product.

### SUMMARY OF THE INVENTION

A method for assembling composite materials into an absorbent composition is herein disclosed wherein the topsheet and at least one absorbent core are bonded to form a composite and then a backsheet is extrusion laminated to the composite. The various components which are combined to form the composite may include a topsheet, one or more absorbent cores, a secondary backsheet, or other components commonly found in absorbent articles. The components may be bonded singularly or in multiple layers. The bonding may include pressure bonding, thermal bonding, ultrasonic bonding, hot needle bonding, or any other suitable bonding method. The bonding may also include bonding an outline in the shape of the desired absorbent article. The backsheet that is extrusion laminated to the composite may be either breathable or nonbreathable.

The resulting composition may be manufactured continuously and in-line as a wide web. The composition may then be stored on a roll until it is to be prepared as a final product. The composition may then be perforated or die cut into a desired article, such as a pantiliner, sanitary pad, diaper, adult incontinence product, food tray, absorbent towel, spill control pillow, wiping article, mattress cover, or other absorbent article. Alternatively, the composition may be fed straight into a bonding machine which bonds the edges of the desired absorbent article.

A method for assembling composite materials into an absorbent composition is also disclosed wherein a wide web of a topsheet and a wide web of at least one core are bonded and then a wide web backsheet is glued to the core in a continuous operation. The wide web format allows for higher output for a given line speed.

A method for assembling composite materials into an absorbent composition is also disclosed wherein the various components of an absorbent article are bonded in one operation. The bonding may include thermal bonding, ultrasonic bonding, hot needle bonding, stitching, or any other effective bonding method.

A method for forming absorbent articles is disclosed wherein a composition having a topsheet, at least one core, and a backsheet are fed through a bonding mechanism which perforates and bonds an outline of the absorbent article. This provides for formation of a final product by using typical bonding equipment which can be arranged in line with the equipment which bonds the materials into a composition.

A method for forming an absorbent article from composite materials is disclosed wherein the composite materials are simultaneously bonded and perforated into an absorbent article. This provides for a simultaneous bonding and forming of the desired product, such that the raw materials are input into this process and final product is the output with no rolls being stored or transported in between.

### BRIEF DESCRIPTION OF THE DRAWINGS

FIG. 1 is a simplified cross-sectional schematic illustration of an exemplary method for forming a composite material for use in absorbent articles in accordance with the present invention.

FIG. 2 is a simplified cross-sectional schematic illustration of an exemplary method for forming a composite material for use in absorbent articles, or for forming absorbent articles, in accordance with the present invention.

FIG. 3 is a simplified cross-sectional schematic illustration of an exemplary method for forming a composite material for use in absorbent articles in accordance with the present invention.

FIG. 4 is a magnified photo of the core side of a backsheet adhesive laminated to absorbent core material.

FIG. 5 is a magnified photo of the core side of a backsheet extrusion laminated to absorbent core material in accordance with an exemplary embodiment of the present invention.

FIG. 6 is a magnified photo of the core side of a backsheet extrusion laminated to absorbent core material in accordance with an exemplary embodiment of the present invention, with the core material removed.

FIG. 7 is a graphical representation of data showing improved performance of an article made in accordance with the present invention.

### DETAILED DESCRIPTION OF THE EXEMPLARY EMBODIMENTS OF THE INVENTION

In each of the processes described in more detail below at least one topsheet, at least one absorbent core layer, and at least one backsheet are formed into an absorbent composite material. Some of the methods describe further processing of this composition. The materials and methods used in these processes are described first as the materials and methods are generally interchangeable between the various methods. For instance, bonding may include thermal bonding, ultrasonic bonding, needle bonding, or pressure bonding. As another example, a topsheet may be replaced by a multi-layer acquisition system including a topsheet combined with one or more acquisition distribution layers.

Definitions

As used herein, the term “absorbent article” means articles that absorb and contain body exudates. More specifically, the term refers to articles which are placed against or in proximity to the body of a wearer for absorbing and containing various exudates discharged from the body. For example, “absorbent article”, as used herein, includes diapers, incontinent articles, sanitary napkins, pantiliners, bandages, and other articles used to absorb body exudates.

Throughout this description, the expressions “topsheet” and “backsheet” denote the relationship of these materials or layers with respect to the absorbent core. It is understood that additional layers may be present between the absorbent core and the topsheet and backsheet, and that additional layers and other materials may be present on the side opposite the absorbent core from either the topsheet or the backsheet.

The term “insult” is used herein to refer to the act of applying a finite amount of liquid to the topsheet of a finished absorbent article. An insult may occur during product use and during finished product testing. Consequently, “multiple insults” occur when the same finished absorbent article is insulted more than once. Multiple insults may occur during product use and during finished product testing.

As used herein, the term “non-woven web” refers to a web that has a structure of individual fibers or threads which are interlaid, but not in any regular, repeating manner. Non-woven webs have been, in the past, formed by a variety of processes such as, for example, meltblowing processes, spun bonding process, and bonded carded web processes.

As used herein, the expression “point bonding” means bonding one or more fabrics at a plurality of discrete points. For example, thermal point bonding generally involves passing one or more layers to be bonded between heated rolls such as, for example, an engraved pattern roll and an anvil (or smooth calendar) roll. The engraved roll is patterned on its surface in some way so that the entire fabric is not bonded over its entire surface, and the anvil roll usually has a flat or smooth surface. As a result, various patterns for engraved rolls have been developed for functional as well as aesthetic reasons.

As used herein, the term “polymer” generally includes, but is not limited to, homopolymers, copolymers, such as, for example, block, graft, random, and alternating copolymers, terpolymers, etc. and blends and modifications thereof. Furthermore, unless otherwise specifically limited, the term “polymer” shall include all possible molecular geometric configurations of the material. These configurations include, but are not limited to, isotactic, syndiotactic and random symmetries.

As used herein, the term “substantially” means that a given property or parameter may vary by about 20% from the stated value.

The term “topsheet” is used herein to refer to the layer of material in a finished absorbent article which is first contacted by liquid during an insult when the article is properly used. It is well known in the art that many finished absorbent articles employ thin sheets of nonwoven materials or perforated films as topsheet. However, this definition of topsheet is not limited to mean only sheets of nonwoven layers and perforated films but instead includes any material composition and in any shape, form, or structure which is the layer first contacted by liquid during an insult when the article is properly used.

As used herein, “wide web” refers to a web of material with a width greater than twice the width of the desired absorbent article to be formed with the material. Wide web will refer to either the raw materials or the composites of raw materials. A wide web format provides for more product given a line speed, but it also may be more difficult to roll, store and transport.

As used herein, the term “compatibility” refers to the ability of a relatively solid polymer to bond with an extruded polymer applied in the vicinity of the first polymer. Typically, two identical polymers will have high compatibility while differing polymers may be less compatible with each other. A polymer with very low compatibility will not bond well with the extruded polymer in question.

As used herein, the phrase “ultrasonic bonding” means a process performed, for example, by passing the fabric between a sonic horn and an anvil roll as illustrated in U.S. Pat. No. 4,374,888 to Bornlaeger. The method of ultrasonic bonding has been used for many years. In this method of bonding, various layers that are to be attached together are simultaneously fed to the bonding nip of an ultrasonic unit. A variety of these units are available commercially. In general, these units produce high frequency vibration energy that melts thermoplastic components at the bond sites within the layers and join them together. Therefore, the amount of induced energy, speed by which the combined components pass through the nip, gap at the nip, as well the number of bond sites determine the extent of adhesion between the various layers. Very high frequencies are obtainable and although energies in excess of 18,000 cps are usually referred to as ultrasonic, depending on the desired adhesion between various layers and the choice of material, frequencies as low as 5,000 cps or even lower may produce an acceptable product.

As used herein, the phrase “thermal bonding” means a process of passing a fabric or web of fibers to be bonded between a heated calender roll and an anvil roll or any other process of applying heat to bond two materials. The method of thermal bonding may also be used in bonding two or more components of web based products together. In this method, heat generated by different means such as hot rolls, microwave energy, air circulating oven, and the like may be used to raise the temperature of the webs that are to be bonded together, to above the softening or glass transition temperature of at least one of the components present in the webs. The applied heat softens the component, and with the aid of pressure, bonds the structures together. One may heat the entire web(s) to achieve point-to-point bond or may heat selective areas of the web(s) resulting in lower bond sites and therefore lower bond strength between the components.

It is also possible to introduce a thermoplastic “bonding” web that may act as the bonding agent between various components. The bonding web may be made from films, woven fabrics, or nonwoven materials having components with low glass transition temperatures that upon heating adhere to other similar components in any and all of the adjacent webs.

As used herein, “needle bonding” refers to a process of pressing heated needles into or through at least two webs such that the areas immediately surrounding the needle are heated to a temperature which approaches the glass transition temperature of at least one of the components of the at least two webs. This provides for bonding in the area of the needle so that the number of bonding sites can be controlled by the number of needles.

As used herein, “pressure bonding” refers to a process in which a web is placed between two elements which exert pressure on the web to bind the various components of the web in the area where pressure is being exerted.

Any of the above bonding methods may incorporate a perforation, or die cutting, function to perforate or die cut desired absorbent articles. The bonding which perforates or die cuts the material will also bond the edges of the absorbent article. For example, if needle bonding is used, a tightly spaced set of needles may be positioned to form an outline of a desired absorbent article. Depending on the spacing, the needles will either create a perforation and bonding along the outline, or if spaced closer together, they may die cut and bond the shape out of the material. The same may be done by adjusting the spacing and concentration of ultrasonic bonding, thermal bonding, and pressure bonding.

The perforating is typically accompanied by an increase in bonding in the area around the edges of the desired absorbent article. This additional bonding acts, to some degree, as a visual guide for later die cutting or removal of the perforated articles. The increased bonding may accompany or replace the perforation.

Materials

Various types of materials such as polyolefins and their copolymers and blends, polyesters, nylons, rayon, polyurethane, polyacrylics, and natural fibers such as wood, jute, cotton, flax, wool, and their blends, can be used in the makeup of the various layers.

For example, the topsheet could be made from carded webs, nonwoven materials or apertured thermoplastic films. The topsheet may include apertured film, various types of nonwovens, carded webs, etc. The topsheet could be made from a variety of polymers, for instance, polyolefins and their copolymers and blends. A nonwoven topsheet may include those made by the method of spunbonding, melt blowing or a combination thereof, needle punching, spunlaced, wet forming, fibrillation, air forming, or the like. If thermoplastic films are used, the films are preferably perforated such that they allow passage of the liquid through them.

Similarly, the backsheet may be any of a wide variety of thermoplastic resins. The variety would include polymers that may be blended with polyethylene as well as polyolefins and their copolymers and blends, polyesters, nylons, rayon, polyurethane, and the like. In particular, blends of polypropylene with a copolymer of ethylene with an alpha-olefin selected from the group consisting of propene, butene, hexene, or octene are preferred. The backsheet may include microporous breathable or non-breathable films, apertured films, or nonwovens.

A preferred method uses a polyethylene base with a small percentage of polypropylene mixed in to make the film compatible with some of the fibers of the core. For instance, if an absorbent core, such as Vizorb 3003, is made from polypropylene with some polyethylene/polypropylene bicomponent fibers used to bind the product together, then it is preferred to use a film compatible with the polyethylene component as well as the polypropylene component.

The core may include materials manufactured by methods such as air laid, needle punched, hydroentangled, etc. The core could be made from various materials such as polyolefins and their copolymers and blends, cellulose and its blends with other thermoplastic polymers, as well as polyesters, nylons, rayon, polyurethane, and the like. Absorbent polymers in various forms may also be included in the core composition. The core, or the absorbent layers, may include nonwoven materials made from such natural and synthetic polymers as noted above, and may or may not include superabsorbent polymers in the form of fibers or powders. A common fiber found in absorbent cores is known as “fluff” in the industry. Fluff is best described as very short paper, or mainly cellulosic, fibers. Fluff is often mixed with other fibrous materials in an absorbent core.

Absorbent cores, especially nonwoven absorbent cores, sometimes include binder fibers. These fibers are typically polyolefin based and may or may not include bicomponent fibers. If bicomponent fibers are included, the bicomponent fibers are usually made from polyethylene and polypropylene; although other combinations of polymers may be used, such as polyesters and similar polymers. The bicomponent fibers may be concentric, with a sheath and a core. Either polyethylene or polypropylene may be in the sheath with the other component in the core. Bicomponent fibers may also be side by side.

An important aspect of preferred embodiments of the present invention is that the extruded backsheet material is compatible with at least some of the fibers of the absorbent core.

Exemplary Methods

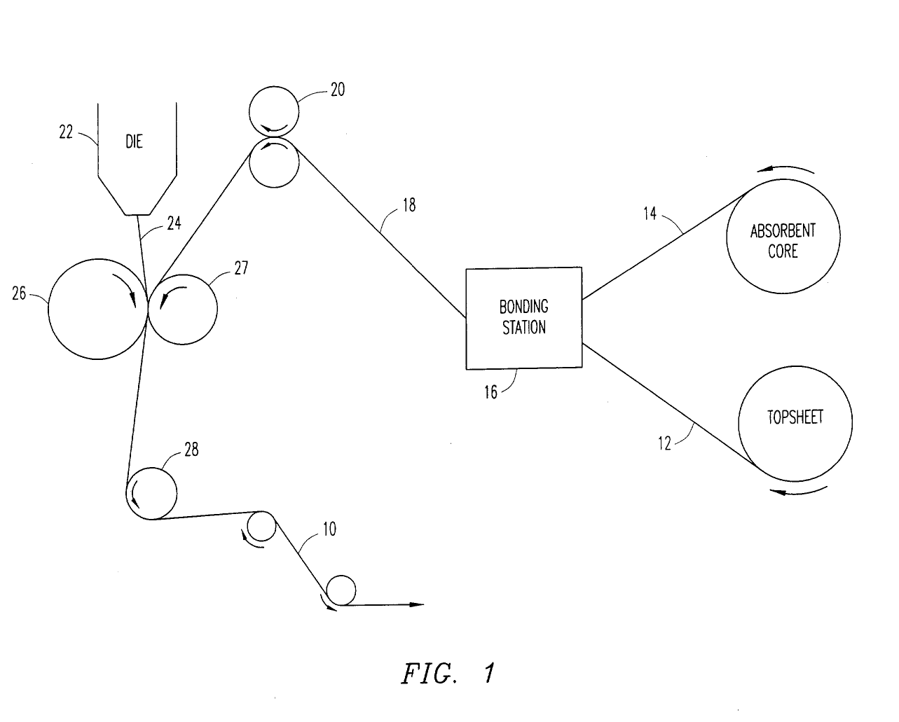

The following discussions describe the exemplary methods shown in FIGS. 1-3, as well as variations that may be employed.

FIG. 1

Referring to FIG. 1, composition 10 is formed by the process shown schematically therein. Topsheet 12 and absorbent core 14 are fed into bonding station 16. While only one absorbent core 14 is shown, it is understood that multiple layers of materials may be used, including multiple absorbent cores, a secondary backsheet, acquisition/distribution layer(s) and other layers commonly found in absorbent articles. Bonding station 16 bonds layers 12 and 14 into a composite 18. Bonding station 16 may also perforate and bond composite 18 with an outline of a desired absorbent article.

After passing through bonding station 16, layers 12 and 14 form composite 18. Composite 18 is passed through a nip roll 20. Die 22 contains a material which creates melt stream 24. Melt stream 24 is extruded by die 22 onto drum 26 and applied to composite 18 under pressure between drums 26 and 27. Melt stream 24 is thereby extrusion laminated onto composite 18 as a backsheet. The composite 18 with melt stream 24 laminated then passes over guide roll 28 to form composition 10.

Composition 10 has several advantages over the prior art method of applying a backsheet with adhesives. The extrusion lamination process described above does not clump the fibers of the absorbent core 14 in the same way adhesives would. Therefore the overall composition has greater absorbency. In particular, the composition has greater strikethrough and rewet performance in the tests described below. Also, because of the elimination of the adhesives the costs of materials are reduced. In addition, the method of ultrasonic bonding, described in more detail below, can, under specific processing conditions, produce tiny holes that facilitate wicking of fluid into the absorbent material. The process described above is preferably carried out in a wide web format to produce more materials for a given line speed and provide more options in perforating and die-cutting to reduce wasted materials.

The advantages of the wide web format may also be used in a method for assembling composite materials into an absorbent composition wherein a wide web of a topsheet and a wide web of at least one core are bonded and then a wide web backsheet is glued to the core in a continuous operation. The resultant product has many advantages over the prior art due to the wide web format.

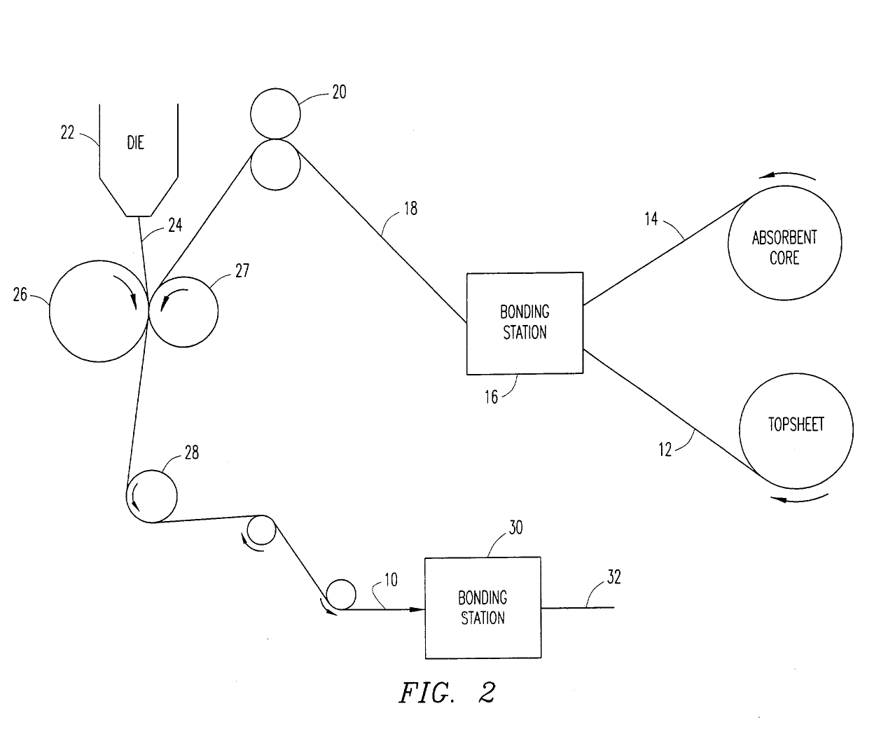

FIG. 2

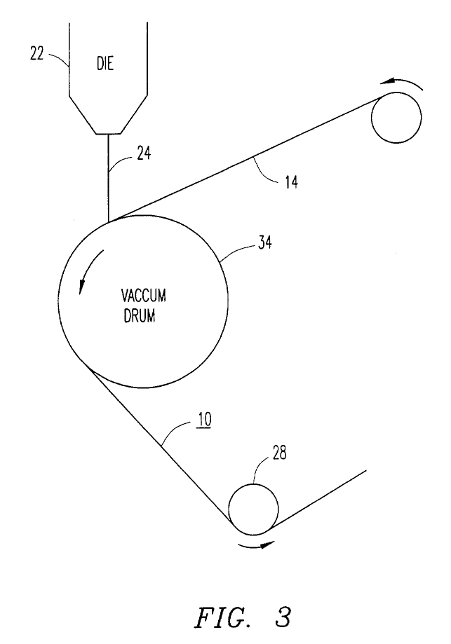

Referring to FIG. 2, a method is shown for forming absorbent articles 32 wherein a composition 10, preferably formed as described above with reference to FIG. 1, having a topsheet 12, at least one core 14, and a backsheet 24, is fed through a bonding station 30 which perforates and bonds an outline of the absorbent article 32 in the composition 10. FIG. 2 shows this process in line with the process of FIG. 1, but it is understood that the forming may be used with any process that has an output with a composition 10 including a topsheet 12, core 14, and backsheet 24. In particular, the process may be used with the processes shown in FIG. 3 or any wide web format process. The advantages of a wide web are more likely to be realized when the raw materials can be formed into an absorbent article in a continuous operation such as this.

The composition 10 is fed into the bonding station 30 which perforates and bonds an outline in the shape of the edges of the desired absorbent article 32. The perforations may allow for later separation or may actually die cut the material at this point, depending on the spacing of the perforations. This provides for formation of a final product by using typical bonding equipment which can be arranged in line with the equipment which bonds the materials into a composition.

FIG. 3

While FIG. 1 and FIG. 2 show exemplary methods of forming a composition 10 and article 32, it is understood that variations can be made to these exemplary methods. For example, backsheet 24 may be extrusion laminated to absorbent core 14 prior to the bonding of topsheet 12. Another variation is shown in FIG. 3 which shows vacuum pressure being used to assist in the bonding of the backsheet 24 to the absorbent core 14. The topsheet 12 may be added to the absorbent core either before or after this operation because it is highly breathable.

Extrusion Lamination

Extrusion lamination is the process by which thermoplastic materials, some of which are described above, are heated to a fluid like consistency and then applied to a substrate or another material to cool into a film. There are many known processes that involve extrusion lamination, but as described above there are problems encountered when films have been laminated onto highly fibrous materials such as absorbent cores.

By controlling the thickness of the extrusion and by choosing appropriate materials for both the extrusion and the fibers of the absorbent core, it has been discovered that a backsheet 24 can be extrusion laminated onto an absorbent core 14, thereby increasing the absorptive performance of the final absorbent product and not decreasing the comfort of the product.

The data below shows that extrusion lamination of the present invention can produce a product with superior strikethrough and rewet as compared to similar articles using adhesive. This advantage is thought to be related to the fact that proper extrusion lamination does not bind the fibers of the core as much as comparable adhesive lamination because the fibers are less bound, they continue to have capillaries into which fluid may be absorbed, thus improving strikethrough and rewet. Where the adhesive binds the fibers of the core material, or where extrusion lamination of the prior art fills the capillaries with extruded material, fluid is not absorbed. This theory is best expressed in microphotos of backsheets attached to absorbent core material.

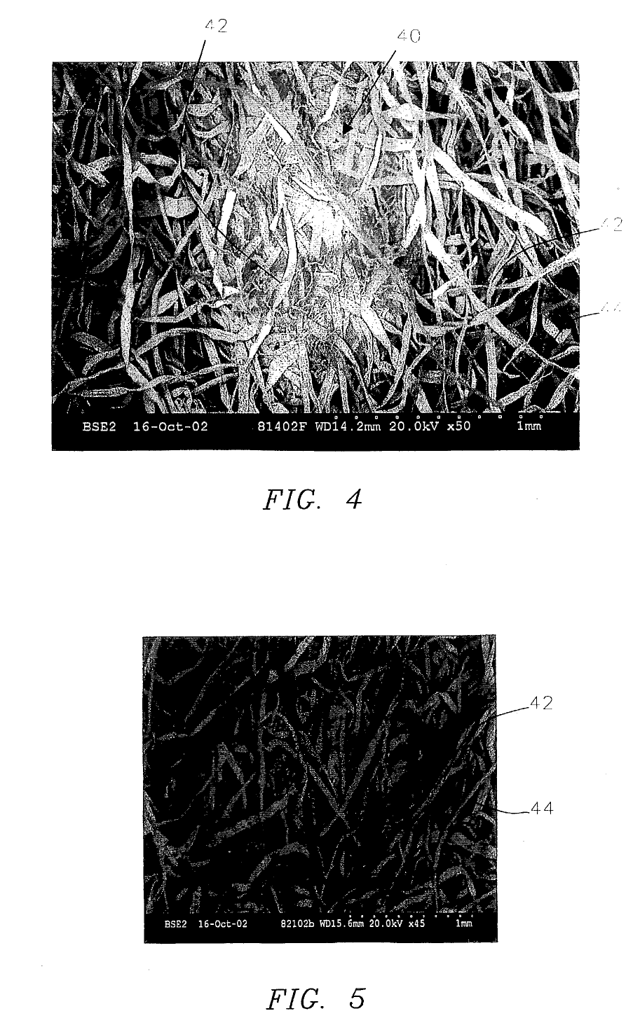

FIG. 4 is a scanning electron microscope photo of the core side of a backsheet which has been attached to an absorbent core with adhesive. The photo clearly shows a clumping 40 of the fibers 42 in the middle of the photo where the adhesive has bonded the fibers 42 together. This can be contrasted with the capillary space 44 shown between the fibers 42 on either side of the clump 40. It is clear that no fluid may be absorbed between the fibers 42 that are bonded together by the adhesive to create clump 40.

In contrast, FIG. 5 is a scanning electron microscopic photo of the core side of a backsheet extrusion laminated to the absorbent core material in accordance with an exemplary embodiment of the present invention. Fibers 42 are not clumped and there is plenty of capillary space 44 between the fibers into which fluid may be absorbed.

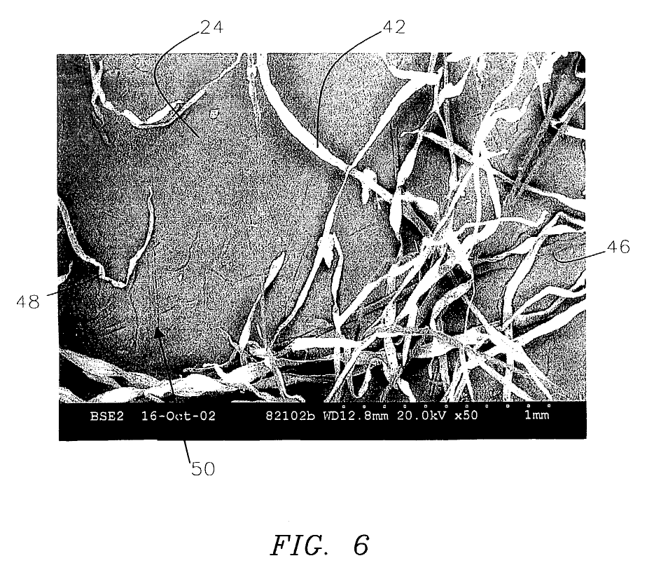

It is believed that the capillary space is preserved because the extruded backsheet 24 bonds with compatible fibers within the absorbent core and does not bond with non-compatible fibers. In effect, backsheet 24 is simultaneously bonded and repelled thus keeping the backsheet attached, but not encouraging the extrudate into the capillary spaces of the absorbent core 14. This can be clearly seen in FIG. 6, which is a scanning electron microscopic photo of a backsheet extrusion laminated to absorbent core material in accordance with an exemplary embodiment of the present invention, with the majority of the core material removed. Fibers 42 are clearly visible on the back drop of the backsheet 24. While some fibers appear to be well bonded to the backsheet 24, such as compatible fibers 46, others appear to be free of the backsheet 24, such as non-compatible fibers 48. An important feature shown in this photo is the existence of impressions 50 on the backsheet 24, showing where non-compatible fibers 48 were embedded in the backsheet 24, but did not bond.

It is believed that this reduction in clumping allows for faster capillary acquisition and allows the fluid to move more freely throughout the absorbent core. This is reflected in improved strikethrough and rewet performance as shown below.

Test Methods

Two test methods were used to demonstrate the improved performance of the articles made in accordance with an exemplary embodiment of the present invention as compared to the prior art. For comparison purposes we have referred to them as the “Manual” test and the “Automatic” test below. The Automatic Test Method, described in more detail below, is based on standard tests EDANA 150.4-99 and 151.2-99, modified for the present application.

Manual Test Method

A 5″×5″ sample of constructed pantiliner is insulted (manually, using a pipette) with 1 ml of Saline 70 solution at an insult area near the middle of the sample and the time for the fluid to fully disappear from the topsheet is recorded to the nearest 0.01 sec as strikethrough #1. A 1.75″ diameter cylindrical weight of 552.5 gms (producing 0.5 PSI) is applied on top of the insult area for 5 minutes. The weight is removed and excess fluid is wiped off of the weight.

After a wait of 15 seconds, the same area is insulted with 1 ml of Saline 70 solution at the insult area near the middle of the sample and the time for the fluid to fully disappear from the topsheet is recorded to the nearest 0.01 sec as strikethrough #2. The 1.75″ diameter cylindrical weight of 552.5 gms (producing 0.5 PSI) is applied on top of the insult area for 5 minutes. The weight is removed and excess fluid is wiped off of the weight.

After a wait of 15 seconds, the same area is insulted with 1 ml of Saline 70 solution at the insult area near the middle of the sample and the time for the fluid to fully disappear from the topsheet is recorded to the nearest 0.01 sec as strikethrough #3. The 1.75″ diameter cylindrical weight of 552.5 gms (producing 0.5 PSI) is applied on top of the insult area for 5 minutes. The weight is removed and excess fluid is wiped off of the weight.

The weight is replaced on top of the insult area for 3 minutes. While the weight is on sample, weigh and record the dry weight of two 5″×5″ pieces of pickup paper. At the end of the 3 minute period, the weight is removed, the excess fluid is not wiped off, place the two pieces of pickup paper on the sample and place weight on top of the pickup paper for 2 minutes.

After the 2 minute period, the weight is removed and the pickup paper. Weigh the wet pickup paper and record the value. The rewet value is calculated as the difference between the dry weight of the pickup paper and the wet weight of the pickup paper normalized by the weight of the dry specimen.

Automatic Test Method

A precut pantiliner sample is placed on a Plexiglas base and is compressed with an 800 g-strikethrough plate with 4″×4″ base dimension with a star shape opening of 0.9375″ in diameter. An insult of 2 ml of test fluid (saline 70) is then dispensed from a burette located about 1 in above the sample onto the surface of the topsheet through the star-shaped hole in the center of the strikethrough plate. A current is registered as the liquid connects the electrodes embedded around the hole in the strikethrough plate and a clock starts the timing. As the fluid penetrates through the topsheet, the electrodes are disconnected again and the current is cut off, stopping the clock. The time elapsed is recorded as the first strikethrough time. A 1.75″ diameter cylindrical weight of 552.50 gms (producing 0.5 PSI) is then applied on top of the insult area for 3 minutes. After the elapsed time, the cylindrical weight is removed without wiping off excess fluid and four pieces of pre-weighed 5″×5″ pickup papers are placed on top of the sample. The cylindrical weight is placed on top of the papers for 2 additional minutes. After the elapsed time, the weight is removed, the weight of wet pickup papers is measured and recorded. The next 2 ml of insult to the same area should start within 60 seconds after the weight is removed. The above steps are repeated to obtain strikethrough times and rewet values for insults 2 and 3.

Test Data

The above test methods were performed on samples of the prior art as well as samples made in accordance with the exemplary methods described herein. For these comparative examples, a 100 gsm air laid core was used with either an extrusion laminated 1 mil backsheet, or an adhesive laminated 1 mil backsheet. To insure that the improvement was not specific to one construction tests were run with either a spunbond nonwoven topsheet or an apertured film topsheet. The tests were repeated 12 times, except for the glued samples with the apertured film topsheet which were only tested 5 times, as shown in the tables below.

The apertured film topsheet used is a white apertured polyethylene film of approximately 24.4 gsm available from Tredegar Film Products of Terre Haute, Ind., under the identification no. X-25155. This film is referred to as CPM in the tables.

The nonwoven topsheet used is a 22 gsm spunbond hydrophilic white product available from BBA Nonwovens of Washougal, Wash., under the identification no. 065SLPV09U.

The absorbent core used is a 100 gsm air laid core available from Buckeye Nonwovens of Delta, B.C., Canada, as Vizorb 3003.

TABLE I
CPM topsheet ultrasonically bonded to a 100 gsm core with
either laminated or glued backsheet

| Manual Test | | | | | | | |
|---|---|---|---|---|---|---|---|
| Method | | ST2, | ST2, | ST3, | ST3, | | |
| St1, L | ST1, G | L | G | L | G | RWT1, L | RWT1, G |
| 0.81 | 1.01 | 1.37 | 1.57 | 2.06 | 1.85 | 0.0211 | 0.0435 |
| 0.92 | 1.11 | 1.06 | 1.60 | 1.26 | 1.91 | 0.0611 | 0.0370 |
| 0.91 | 1.23 | 1.20 | 1.44 | 1.76 | 2.24 | 0.0251 | 0.0213 |
| 0.92 | 1.27 | 1.02 | 1.78 | 1.71 | 2.31 | 0.0188 | 0.0220 |
| 0.83 | 1.17 | 1.20 | 1.77 | 1.73 | 1.91 | 0.0193 | 0.0188 |
| 0.85 | | 1.35 | | 1.43 | | 0.0119 | |
| 0.92 | | 1.79 | | 1.63 | | 0.0110 | |
| 0.96 | | 1.24 | | 1.79 | | 0.0188 | |
| 1.00 | | 1.41 | | 1.52 | | 0.0250 | |
| 1.01 | | 1.18 | | 1.84 | | 0.0125 | |
| 0.99 | | 1.20 | | 1.48 | | 0.0142 | |
| 0.87 | | 1.16 | | 1.36 | | 0.0143 | |
| Averages | | | | | | | |
| 0.92 | 1.16 | 1.27 | 1.63 | 1.63 | 2.04 | 0.02 | 0.03 |

Lam: backsheet is laminated.
GLU: backsheet is glued
ST#L: Strikethrough # for laminated products,
ST#G: Strikethrough # for glued products

TABLE II
CPM topsheet ultrasonically bonded to 100 gsm core with either laminated or
glued backsheet

| Automatic Test | | | | | | | | | | | |
|---|---|---|---|---|---|---|---|---|---|---|---|
| Method | | | | | | | | | | | |
| ST1, L | ST1, G | ST2, L | ST2, G | ST3, L | ST3, G | RWT1, L | RWT1, G | RWT2, L | RWT2, G | RWT3, L | RWT3, G |
| 0.96 | 1.02 | 1.58 | 1.51 | 2.40 | 2.54 | 0.0085 | 0.0074 | 0.0109 | 0.0109 | 0.0109 | 0.0112 |
| 1.04 | 1.44 | 1.48 | 2.09 | 2.36 | 2.88 | 0.0082 | 0.0072 | 0.0135 | 0.0101 | 0.0348 | 0.0134 |
| 0.80 | 1.27 | 1.38 | 1.88 | 2.39 | 2.83 | 0.0073 | 0.0075 | 0.0102 | 0.0117 | 0.0120 | 0.0178 |
| 0.88 | 1.31 | 1.51 | 1.97 | 2.55 | 2.78 | 0.0100 | 0.0073 | 0.0105 | 0.0101 | 0.0114 | 0.0121 |
| 1.06 | 1.07 | 1.49 | 2.25 | 2.61 | 3.04 | 0.0084 | 0.0073 | 0.0112 | 0.0104 | 0.0125 | 0.0120 |
| 0.99 | | 1.45 | | 2.55 | | 0.0046 | | 0.0066 | | 0.0064 | |
| 1.18 | | 1.34 | | 2.71 | | 0.0063 | | 0.0098 | | 0.0206 | |
| 1.03 | | 1.54 | | 2.98 | | 0.0055 | | 0.0265 | | 0.0080 | |
| 0.89 | | 1.71 | | 2.82 | | 0.0054 | | 0.0128 | | 0.0081 | |
| 1.02 | | 1.48 | | 2.56 | | 0.0066 | | 0.0164 | | 0.0084 | |
| 1.23 | | 1.55 | | 2.51 | | 0.0058 | | 0.0078 | | 0.0081 | |
| 0.76 | | 1.68 | | 2.75 | | 0.0052 | | 0.0079 | | 0.0098 | |

Averages

| | | | | | | | | | | | |
|---|---|---|---|---|---|---|---|---|---|---|---|
| 0.99 | 1.22 | 1.52 | 1.94 | 2.60 | 2.81 | 0.01 | 0.01 | 0.01 | 0.01 | 0.01 | 0.01 |

ST#L: Strikethrough # for laminated products,
ST#G: Strikethrough # for glued products.

TABLE III
Spunbond TS ultrasonically bonded to 100 gsm core with
either laminated or glued BS

| MANUAL INSULT | | | | | | | |
|---|---|---|---|---|---|---|---|
| LAM | GLUED | LAM | GLUE | LAM | Glue | Rewet | Rewet |
| ST1L | ST1G | ST2L | ST2G | ST3L | ST3G | LAM | GLU |
| 0.85 | 0.74 | 1.59 | 2.31 | 2.92 | 3.05 | 0.741 | 0.750 |
| 0.91 | 0.87 | 1.77 | 2.42 | 3.06 | 3.62 | 0.713 | 0.711 |
| 0.91 | 0.88 | 1.88 | 1.76 | 3.02 | 3.36 | 0.719 | 0.689 |
| 0.95 | 0.9 | 1.55 | 1.88 | 2.68 | 2.39 | 0.722 | 0.731 |
| 0.96 | 0.89 | 1.67 | 1.65 | 3.01 | 2.01 | 0.703 | 0.729 |
| 0.93 | 0.9 | 1.35 | 1.59 | 2.63 | 2.43 | 0.668 | 0.696 |
| 1.09 | 0.92 | 1.43 | 1.49 | 2.77 | 2.89 | 0.673 | 0.681 |
| 0.94 | 0.95 | 1.49 | 1.38 | 2.72 | 2.67 | 0.645 | 0.681 |
| 1.01 | 0.84 | 1.6 | 1.79 | 2.75 | 3.46 | 0.695 | 0.657 |
| 0.99 | 0.9 | 1.33 | 1.4 | 2.21 | 2.71 | 0.685 | 0.653 |
| 0.77 | 0.92 | 1.45 | 1.79 | 2.38 | 2.58 | 0.683 | 0.658 |
| 0.98 | 0.88 | 1.58 | 2.24 | 2.46 | 2.65 | 0.696 | 0.650 |
| Averages: | | | | | | | |
| 0.941 | 0.883 | 1.558 | 1.808 | 2.718 | 2.818 | 0.695 | 0.690 |

Lam: backsheet is laminated.
GLU: backsheet is glued

TABLE IV
Spunbond TS ultrasonically bonded to 100 gsm core with either laminated or glued BS

| AUTOMATIC | | | | | | | | | | | |
|---|---|---|---|---|---|---|---|---|---|---|---|
| INSULT | | | | | | | | | | | |
| ST1, L | ST1, G | ST2, L | ST2, G | ST3, L | ST3, G | RWT1, L | RWT1, G | RWT2, L | RWT2, G | RWT3, L | RWT3, G |
| 0.93 | 1.58 | 1.23 | 1.63 | 1.94 | 2.16 | 0.276 | 0.276 | 0.289 | 0.311 | 0.311 | 0.315 |
| 0.92 | 1.54 | 0.81 | 1.46 | 2.13 | 2.53 | 0.281 | 0.277 | 0.295 | 0.285 | 0.302 | 0.302 |
| 0.94 | 1.55 | 0.99 | 1.52 | 1.51 | 2.94 | 0.263 | 0.262 | 0.303 | 0.281 | 0.302 | 0.299 |
| 0.95 | 1.23 | 1.03 | 1.38 | 1.67 | 2.64 | 0.279 | 0.272 | 0.288 | 0.293 | 0.304 | 0.322 |
| 0.96 | 1.51 | 0.92 | 1.54 | 1.35 | 2.64 | 0.278 | 0.277 | 0.298 | 0.292 | 0.306 | 0.299 |
| 1.15 | 1.18 | 1.14 | 1.48 | 1.82 | 1.81 | 0.302 | 0.269 | 0.301 | 0.312 | 0.318 | 0.313 |
| 1.15 | 1.40 | 1.15 | 1.36 | 2.06 | 1.89 | 0.284 | 0.284 | 0.310 | 0.308 | 0.321 | 0.320 |
| 1.10 | 1.19 | 1.06 | 1.60 | 1.39 | 1.80 | 0.282 | 0.286 | 0.307 | 0.313 | 0.321 | 0.315 |
| 1.14 | 1.29 | 1.08 | 1.53 | 1.75 | 1.91 | 0.287 | 0.278 | 0.316 | 0.308 | 0.331 | 0.308 |
| 1.15 | 1.33 | 1.35 | 1.52 | 1.77 | 1.88 | 0.265 | 0.285 | 0.324 | 0.267 | 0.323 | 0.344 |
| 1.03 | 1.33 | 1.25 | 1.41 | 1.34 | 1.98 | 0.266 | 0.288 | 0.326 | 0.301 | 0.304 | 0.310 |
| 0.89 | 1.35 | 1.14 | 1.47 | 1.60 | 1.82 | 0.271 | 0.275 | 0.303 | 0.296 | 0.322 | 0.317 |

Averages

| | | | | | | | | | | | |
|---|---|---|---|---|---|---|---|---|---|---|---|
| 1.03 | 1.37 | 1.10 | 1.49 | 1.69 | 2.17 | 0.28 | 0.28 | 0.30 | 0.30 | 0.31 | 0.31 |

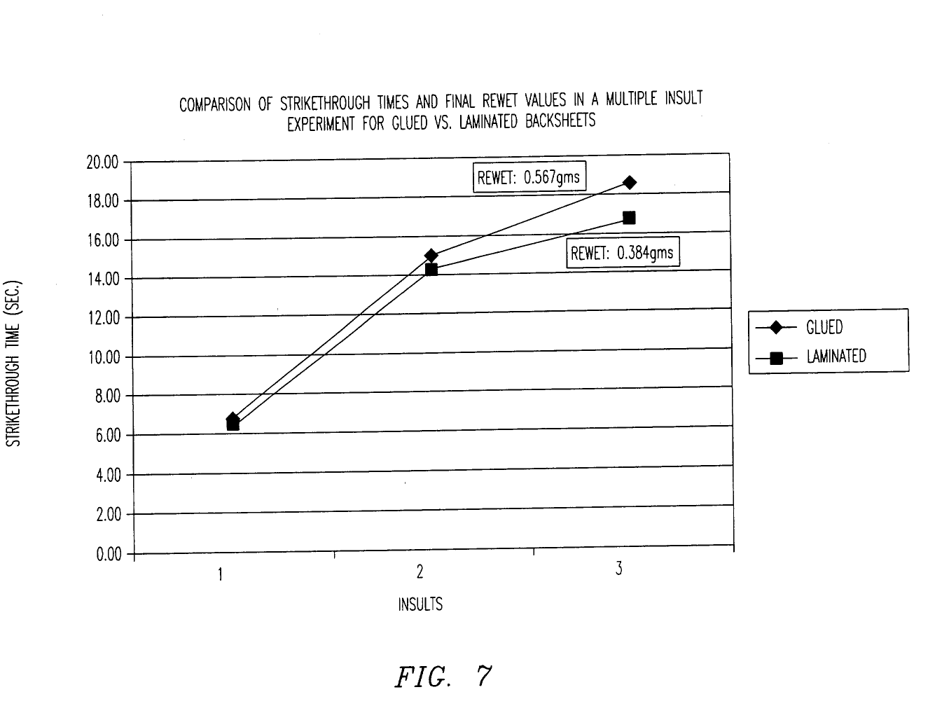

FIG. 7

Further tests were conducted using the apertured film topsheet mentioned above attached to an 80 gsm absorbent core and a backsheet, either extrusion laminated in accordance with the present invention or adhesive laminated as is known in the prior art. These tests used the above described topsheets, with a thin core of 80 gsm containing approximately 80% fluff pulp and 20% bonding fibers, available from Concert Industries in Gatineau, Quebec, Canada, as product code 080.1250. The results of these tests are shown in FIG. 7.

Conclusion

While particular embodiments of the present invention have been illustrated and described, it would be obvious to those of skill in the art that various other changes and modifications can be made without departing from the spirit and scope of the invention. It is therefore intended to cover, in the appended claims, all such changes and modifications that are within the scope of this invention.

We claim:

1. A process for assembly of an absorbent composition comprising the steps of:
bonding at least one absorbent material to a topsheet material to create a composite; and
extrusion laminating a backsheet to said composite to form the absorbent composition.

2. The process of claim 1 wherein:
the absorbent material contains fibers,
the backsheet is comprised of a first thermoplastic material; and
a portion of the fibers of the absorbent material are comprised, at least in part, of a second thermoplastic material, the second thermoplastic material being compatible with the first thermoplastic material.

3. The process of claim 1 wherein:
the absorbent core is comprised of fluff and polymeric bonding fibers;
the backsheet is comprised of a polymeric film; and
the polymeric film is compatible with said polymeric bonding fibers.

4. The process of claim 1 comprising the further step of applying pressure to the extrusion laminate.

5. The process of claim 4 wherein said pressure is applied using nip rollers.

6. The process of claim 4 wherein said pressure is applied using a vacuum drum.

7. The process of claim 1 wherein the absorbent material comprises air laid nonwoven polyolefin fibers.

8. The process of claim 1 wherein the absorbent material comprises bicomponent fibers.

9. The process of claim 8 wherein the bicomponent fibers include polyethylene and polypropylene.

10. The process of claim 8 wherein the bicomponent fibers are concentric.

11. An absorbent composition comprising:
a topsheet material;
at least one absorbent core material bonded to said topsheet material to form a composite; and
a backsheet material extrusion laminated to said composite opposite said topsheet material.

12. The absorbent composition of claim 11 wherein:
the absorbent material contains fibers;
the backsheet is comprised of a first thermoplastic material; and
a portion of the fibers of the absorbent material are comprised, at least in part, of a second thermoplastic material, the second thermoplastic material being compatible with the first thermoplastic material.

13. The composition of claim 11 wherein:
the absorbent core is comprised of fluff and polymeric bonding fibers;
the backsheet is comprised of a polymeric film; and
the polymeric film is compatible with said polymeric bonding fibers.

14. The composition of claim 11 wherein the absorbent material comprises air laid nonwoven polyolefin fibers.

15. The composition of claim 11 wherein the absorbent material comprises bicomponent fibers.

16. The composition of claim 15 wherein the bicomponent fibers include polyethylene and polypropylene.

17. The composition of claim 15 wherein the bicomponent fibers are concentric.

18. An absorbent article comprising:
a topsheet material;
at least one absorbent core material bonded to said topsheet material to form a composite; and
a backsheet material extrusion laminated to said composite opposite said topsheet material.

19. The absorbent article of claim 18 wherein:
the absorbent material contains fibers,
the backsheet is comprised of a first thermoplastic material; and
a portion of the fibers of the absorbent material are comprised, at least in part, of a second thermoplastic material, the-second thermoplastic material being compatible with the first thermoplastic material.

20. The absorbent article of claim 18 wherein:
the absorbent core is comprised of fluff and polymeric bonding fibers;
the backsheet is comprised of a polymeric film; and
the polymeric film is compatible with said polymeric bonding fibers.

21. The absorbent article of claim 18 wherein the absorbent material comprises air laid nonwoven polyolefin fibers.

22. The absorbent article of claim 18 wherein the absorbent material comprises bicomponent fibers.

23. The absorbent article of claim 22 wherein the bicomponent fibers include polyethylene and polypropylene.

24. The absorbent article of claim 22 wherein the bicomponent fibers are concentric.
